(19) United States
(12) Patent Application Publication
(10) Pub. No.: US 2015/0346007 A1
(43) Pub. Date: Dec. 3, 2015

(54) Detecting Anomalies Based on an Analysis of Input and Output Energies

(71) Applicant: Microsoft Corporation, Redmond, WA (US)

(72) Inventors: Sean M. James, Olympia, WA (US); Eric C. Peterson, Woodinville, WA (US)

(73) Assignee: Microsoft Corporation, Redmond, WA (US)

(21) Appl. No.: 14/288,348

(22) Filed: May 27, 2014

(51) Int. Cl. G01F 9/00; G01M 3/26

(52) U.S. Cl. CPC G01F 9/001; G01M 3/26

(57) ABSTRACT

An analysis system is described herein for detecting anomalies within an environment based on a consideration of resources supplied to, and then used by, resource consumption devices within the environment. For instance, in one implementation, the analysis system may detect leaks of natural gas in a data processing environment based on a consideration of discrepancies in the amounts of gas supplied to the resource consumption devices, relative to the amounts of energy produced by the resource consumption devices, as a result of the use of the gas. In addition, or alternatively, the analysis system may detect abnormal degradation of the resource consumption devices within the data processing environment, such as its fuel cells or generators. That degradation may be attributable to intrinsic failures associated with the fuel cells or generators, and/or to the nature of the loads that have been applied to the fuel cells or generators.

### BACKGROUND

An environment may include one or more devices that consume natural gas, either directly or indirectly. For example, an environment may use one or more generators and/or fuel cells to convert natural gas into electrical energy. The environment may then use the electrical energy to power other devices, such as data processing equipment. Hence, the generators and fuel cells may be said to directly consume the natural gas, while the data processing equipment may be said to indirectly consume the natural gas.

Traditionally, an environment may detect gas leaks using gas detectors that are dispersed throughout the environment. For example, the environment may use chemical sensors to directly detect the physical presence of natural gas. In addition, the environment may include sensors which detect conditions that may be accompanied by a gas leak. For example, the environment may use seismic sensors to detect seismic events that often lead to breaks in a gas delivery system.

The above-described traditional gas detection techniques, however, may not, by themselves, provide a wholly satisfactory solution for detecting leak-related failures in some environments.

### SUMMARY

An analysis system is described herein for detecting anomalies within an environment based on a consideration of the amount of a resource supplied to, and then used by, resource consumption devices within the environment. The use of the resource by the resource consumption devices is reflected by output energy produced by the resource consumption devices.

In one implementation, for instance, the analysis system may detect leaks of natural gas in a data processing environment based on a consideration of discrepancies in the amount of gas supplied to the resource consumption devices, relative to the amount of output energy produced by the resource consumption devices. In other cases, the analysis system may attribute anomalies in the data processing environment to intrinsic failures of the resource consumption devices, and/or to the nature of the loads that have been applied to the resource consumption devices.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a setting that uses an analysis system to detect anomalies within an environment.

FIG. 2 shows two racks of computing devices within one particular data processing environment.

FIG. 3 depicts one principle of operation of the analysis system, of FIG. 1.

FIG. 4 shows one implementation of the analysis system of FIG. 1.

FIGS. 5-7 are graphs that are used in explaining different types of analysis that may be performed by the analysis system of FIG. 4.

FIG. 8 is a flowchart that describes one manner of operation of the analysis system of FIG. 4.

FIG. 9 shows illustrative computing functionality that can be used to implement any aspect of the features shown in the foregoing drawings.

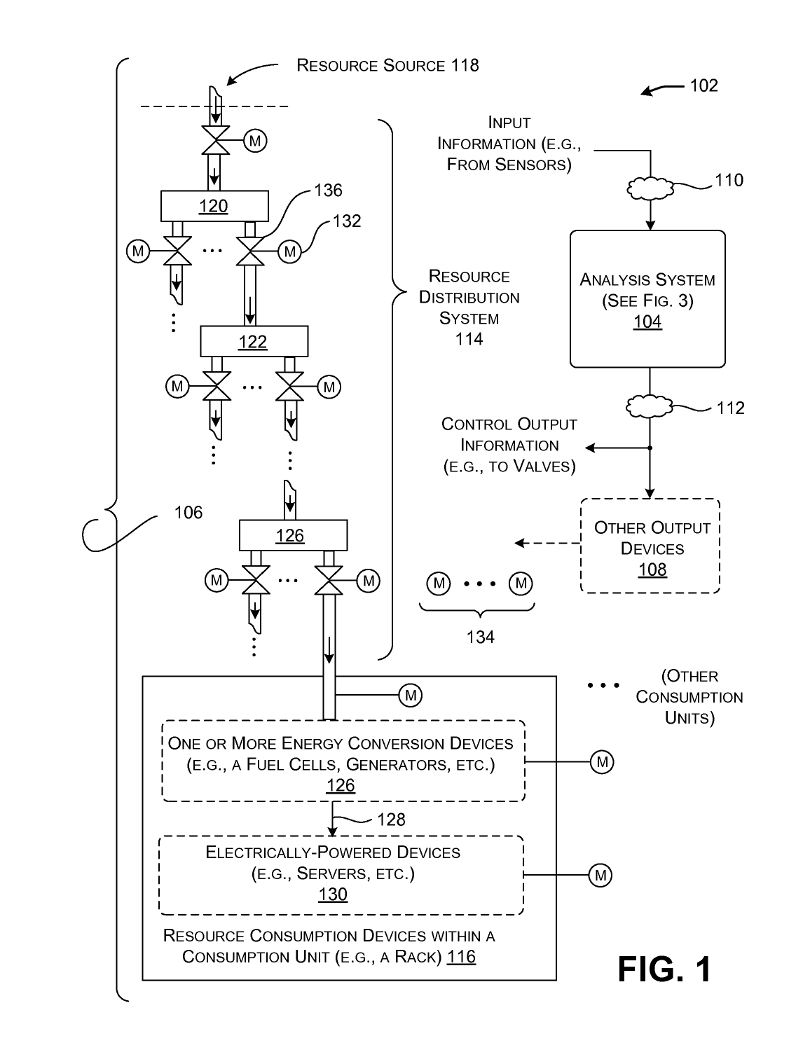

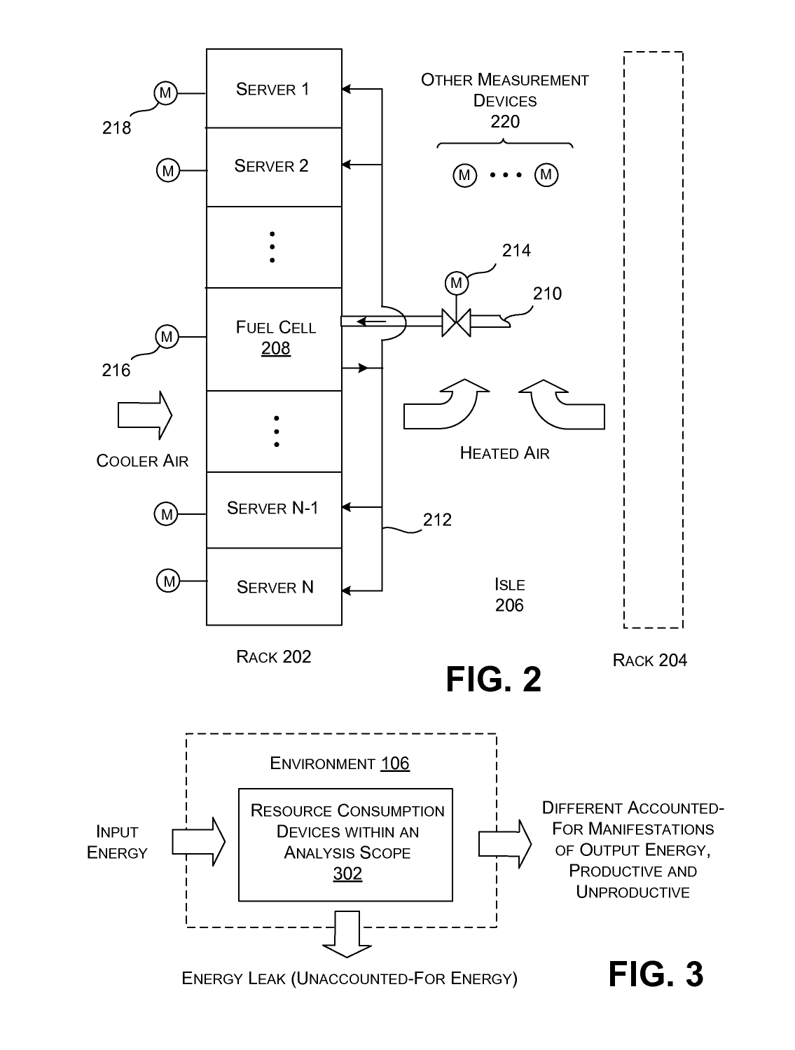

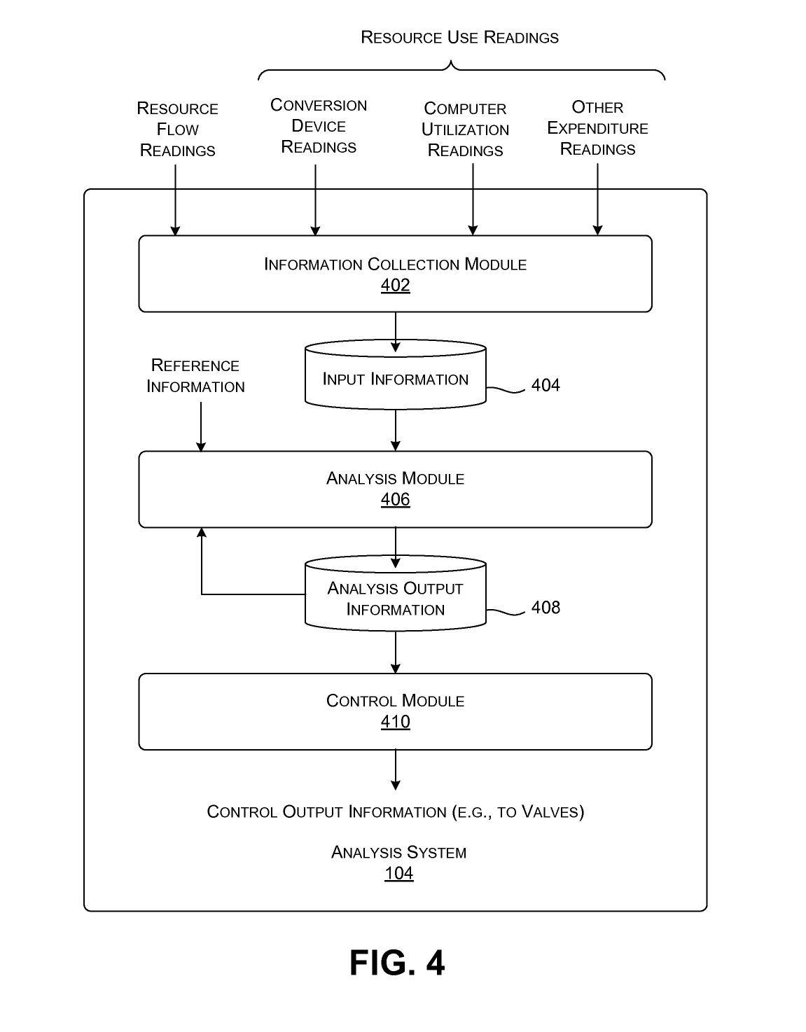

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative analysis system for detecting and responding to anomalies in an environment, pertaining to the use of a resource in the environment. Section B sets forth illustrative methods which explain the operation of the analysis system of Section A. Section C describes illustrative computing functionality that can be used to implement any aspect of the features described in Sections A and B.

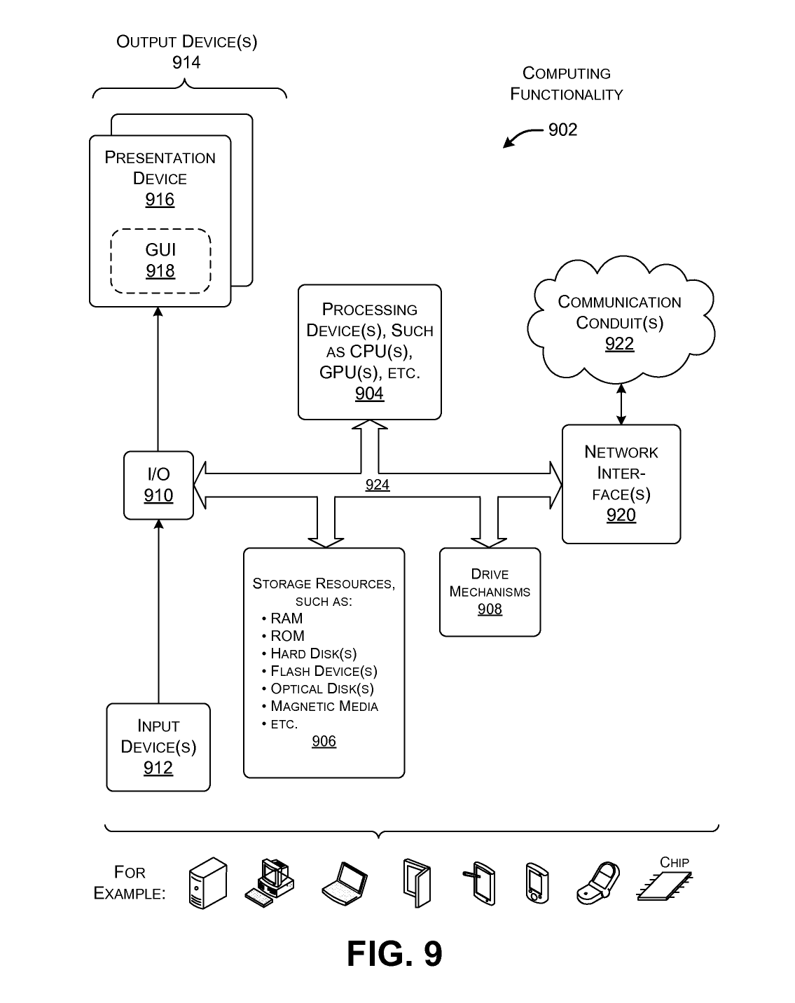

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 9, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Finally, the terms “exemplary” or “illustrative” refer to one implementation among potentially many implementations.

A. Illustrative Crowdsourcing Environment.

FIG. 1 shows an overview of a setting 102 that uses an analysis system 104 to detect anomalies within an environment 106. The anomalies pertain to the manner in which the environment 106 consumes a resource. In the principal example set forth herein, the environment 106 corresponds to a data processing environment (such as a data center), and the resource corresponds to natural gas. In that setting, the environment 106 uses one or more gas conversion devices (such as fuel cells, generators, etc.) to convert the natural gas into electrical energy. The environment 106 uses the electrical energy to power a collection of computing devices (e.g., servers), which perform respective computing functions. Here, both the gas conversion devices and computing devices may be referred to as gas consumption devices. That is, the gas conversion devices directly consume the gas by converting the gas to electrical energy. The computing devices indirectly consume the gas because their electrical energy originates form the gas conversion devices, which, in turn, are fueled by gas.

In other implementations, the environment 106 may correspond to other settings in which devices consume natural gas. For example, the environment 106 may correspond to an apartment building or the like which uses natural gas to power furnaces, fireplaces, stoves, etc. Or the environment 106 may correspond to a manufacturing plant that uses one or more types of gases in a manufacturing process, such as a chip fabrication process, and so on.

In still other implementations, the environment 106 may include resource consumption devices that consume other types of resources, that is, instead of, or in addition to, natural gas. For example, the environment 106 may correspond to a building of any type that receives its primary power from a utility-based electrical power supply, and/or a solar-based power supply, and/or a battery-based power supply, etc. Or the environment 106 may correspond to a building, greenhouse, or agricultural field, etc. that consumes a water resource. Or the environment 106 may correspond to a hospital or the like which consumes oxygen and other medically-useful gases in the care of its patients, and so on.

The principles described here may be applied to yet other types of environments, resources, and resource consumption devices. Again, however, to facilitate explanation, the setting 102 will mainly be described below in the illustrative context in which the environment 106 corresponds to a data processing environment, the resource corresponds to natural gas, and the resource consumption devices correspond to gas conversion devices and computing devices.

The analysis system 104 may be implemented by one or more computing devices. The analysis system 104 operates by receiving input information which describes the flow of the resource (e.g., gas) to the resource consumption devices. The analysis system 104 also receives input information which describes the consequences of the resource consumption devices' use of the resource that is supplied to them. The analysis system 104 uses this input information to generate control output information. The control output information indicates whether or not there is an anomaly within the environment 106.

For example, the anomaly may indicate that is an imbalance between an amount of resource (e.g., gas) that is supplied to the resource consumption devices, compared to the amount of resource that is being used by the resource consumption devices. That discrepancy, in turn, may indicate that the environment 106 is leaking the resource, resulting in the inability of the full amount of the resource to reach whatever mechanisms are used to consume it within the environment 106.

Alternatively, or in addition, the anomaly may indicate that there is some problem with at least one resource consumption device, such as a fuel cell or generator. In that case, the resource consumption device is receiving the resource, but is not using it in an expected “normal” manner. The failure of the resource consumption device, in turn, may be attributable to a degradation in the resource consumption device due to some intrinsic characteristic (e.g., due to a faulty part), and/or due to the manner in which it is being used within the environment 106. Additional details will be provided below regarding the manner in which the analysis system 104 may interpret the input information that it is fed to it.

The analysis system 104 may use the output control information to control one or more output devices in the environment 106. For example, the output devices may include solenoid-actuated valves within the environment 106 (to be described below) and/or other output devices 108 (such as a ventilation system, an alarm, etc.).

In one implementation, the analysis system 104 corresponds to an on-site component of the environment 106, and may be considered a part of the environment 106 itself. In another case, the analysis system 104 may correspond to a component that is remote from the environment 106. For example, the analysis system 104 may receive the input information from the environment 106 via a first computing network 110, and supply the control output information to the environment 106 using a second computing network 112. In one case, the first and second computing networks (110, 112) may correspond to the same computing network, which, in turn, may correspond to any type of wide area network (such as the Internet), or a local area network, or some combination thereof.

Further, although not depicted in FIG. 1, the analysis system 104 may control plural environments that are dispersed over a geographic area of any scope, such by controlling multiple data centers in different parts of a region, country, or the entire world. In that case, the analysis system 104 can use the computing network 110 to receive input information from plural environments, and use the computing network 112 to send control output information to the plural environments. In some cases, the analysis system 104 can control each environment in an independent manner. In other cases, the analysis system 104 may combine the input information received from plural environments to more effectively establish trends and other statistical measures; it may then use that aggregated insight in its control of each environment.

Without limitation, the representative environment 106 shown in FIG. 1 includes a resource distribution system 114 for distributing a resource (such as natural gas) to a plurality of resource consumption units, such as the representative resource consumption unit 116. For the case in which the resource is gas, the resource distribution system 114 may receive a main supply of natural gas from any source 118, such as a main supply line maintained by a public utility. The resource distribution system 114 may then deliver the gas to a plurality of resource consumption units through a plurality of gas delivery conduits and manifolds.

For example, in the representative depiction shown in FIG. 1, the resource distribution system 114 includes at least three manifolds (120, 122, 124), although the resource distribution system 114 can include any number of manifolds. Each manifold receives a supply of gas through at least one gas input conduit. The manifold then distributes the received gas among two or more gas output conduits. Each lowest-tier manifold, such as the representative manifold 124, may distribute gas to a plurality of resource consumption units, such as the representative resource consumption unit 116.

Each resource consumption unit may host one or more resource consumption devices. In the illustrative case of FIG. 1, the resource consumption unit 116 may include one or more energy conversion devices 126, such as one or more fuel cells and/or one or more generators. These energy conversion device(s) 126 generate electrical energy 128. The resource consumption unit 116 may also include one or more electrically-powered devices 130 which receive their power from the electrical energy 128. Although not shown, the electrically-powered devices 130 may also receive supplemental power from any other energy source(s), such as a public utility electrical power source, a battery power source, a solar power source, a wind turbine power source, and so on.

More specifically, a fuel cell corresponds to any type of device which converts the chemical energy of a fuel (such as natural gas) directly into electricity through the chemical reaction of the fuel with an agent, such as oxygen. A generator corresponds to any type of device that uses any type of engine to convert, through combustion, the chemical energy of a fuel into mechanical motion energy, and then converts the motion energy into electricity.

As stated above, the energy conversion device(s) 126 directly consume gas because they are directly driven by the received gas. The electrical-powered devices 130 may be said to be indirectly powered by the gas because they ultimately, although not directly, are powered through the supply of gas to the resource consumption unit 116.

In one implementation, each resource consumption unit may correspond to a rack within a data center. The rack includes at least one fuel cell or generator for converting gas to electrical energy. The rack also includes plural servers which are powered based on the electrical energy that is produced by the rack's fuel cell or generator. FIG. 2 (described below) sets forth additional information regarding this particular implementation of a resource consumption unit.

In other cases, each resource consumption unit may include only a collection of direct-type resource consumption devices. For example, a resource consumption unit may correspond to a room in an apartment building having any of a gas-powered furnace, a fireplace, a stove, etc., all of which consume gas, yet do not supply power to any “downstream” devices.

The environment 106 includes a plurality of measurement devices for providing measurements that reflect the operation of the environment 106. Each measurement is referred to herein as a reading. FIG. 1 symbolically depicts each measurement device using the symbol “M”.

For example, the resource distribution system 114 may include a plurality of flow meters that measure the flow of gas through the gas conduits and manifolds of the resource distribution system 114. For instance, the environment 106 may use a flow meter to measure the flow of gas in a main gas conduit that supplies gas to the environment 106 as a whole. The environment 106 may also use one or more flow meters to measure flow in each output conduit that exits a manifold. For example, FIG. 1 shows one representative flow meter 132 that measures flow in one output gas conduit associated with the manifold 120. The environment 106 may also use one or more flow meters to measure flow at the input to each energy conversion device (e.g., at each fuel cell, generator, etc.). More generally, different environments 106 may position flow meters at different locations in their resource distribution systems, based on the particular nature of each resource distribution system and/or other factors.

One or more other measurement devices may provide use readings, each reflecting an outcome of the use of gas (or other resource) by at least one resource consumption device. For example, the energy conversion device(s) 126 in the resource consumption unit 116 may include one or more measurement devices that measure the electrical energy supplied by the energy conversion device(s) 126. For instance, any of these measurement devices can describe the current, voltage, power, etc. supplied by each energy conversion device. Generally, these use readings are referred to herein as conversion device readings.

The electrically-powered devices 130 may also include one or more measurement devices that measure the amount of work performed by the electrically-powered devices 130, using the electrical energy 128 supplied by the energy conversion device(s) 126. For example, any of these measurement devices can provide information regarding the processor utilization of a computing device, the memory utilization of a computing device, the throughput of a computing device, and so on. Such measure devices may be implemented as software modules, hardware modules, and/or some combination thereof. Generally, these use readings are referred to herein as computer utilization readings.

The conversion device readings and the computer utilization readings measure the outcome of the productive, or desired, use of the gas resource. In addition, the energy conversion device(s) 126 and the electrically-powered devices 130 may use the gas in ways that are unproductive, and are tangential to the desired use of the gas. For example, the energy conversion device(s) 126 and the electrically-powered devices 130 may generate heat as a byproduct of their operation, which represents an unproductive use of the gas. One or more other measurement devices 134 may be dispersed throughout the environment 106 to measure the outcome of any unproductive consumption of gas. For example, one such measurement device may measure temperature in proximity to a particular device, or within a “hot” isle of a data center, etc. Generally, all such other use readings are referred to herein as other expenditure readings.

In addition, the environment 106 may use other gas sensors to detect the leakage of gas. For example, the other gas sensors may include chemical sensors which chemically detect the presence of gas, acoustic sensors which detect the sound of leaking gas, thermal sensors which detect heat associated with the release of gas, and so on.

The environment 106 may include a dispersed collection of output devices for controlling the flow of the gas resource. For example, the resource distribution system 114 may include a plurality of solenoid-actuated valves that control the flow of gas through respective gas conduits and manifolds. For instance, a representative valve 136 controls the flow of gas through an output gas conduit associated with the manifold 120. As noted above, other output devices 108 may include alarms, ventilation control systems, etc.

FIG. 2 shows two racks (202, 204) in a data processing environment. Each rack is an example of a resource consumption unit, according to the terminology set forth in the explanation of FIG. 1. FIG. 2 explains the illustrative composition of one illustrative rack 202. The other rack 204 may have the same composition as the rack 202, although not specifically shown in FIG. 2.

Further, the data processing environment may include many additional racks, although not depicted in FIG. 2. For example, the rack 202 may correspond to a single rack in a first row of racks. The rack 204 may correspond to a single rack in a second row of racks. An isle 206 may separate the first row of racks from the second row of racks. More specifically, the isle 206 may correspond to the “hot” isle between the two rows because the data processing environment may pass cool air through the rows into the shared isle 206; the components of the racks heat the air up, such that is leaves the racks at a higher temperature compared to that at which it entered. The data processing environment may vent the heated air through the ceiling, or through some other ventilation scheme. This configuration, however, is cited by way of illustration, not limitation; other data processing environments may arrange equipment in other configurations.

The illustrative rack 202 includes a collection of electrically-powered devices, such as servers 1-N. Each server includes one or more processing devices and memory, among other electrical components. Further, each server performs any computations defined by computer instructions. For example, each server may host online applications or parts of these applications. More specifically, in one implementation, all servers within a rack execute the same application(s). In another implementation, the servers within a rack may, at least in part, execute different respective applications.

The rack 202 further includes at least one fuel cell 208 that converts gas, supplied via a gas supply conduit 210, into electrical energy. Power lines 212 then feed the electrical energy to the respective servers.

At least one measurement device 214 measures the flow of gas into the fuel cell 208. The output of this measurement device 214 constitutes a flow reading, in the terminology set forth above. One or more other measurement devices 216 measure the electrical energy generated by the fuel cell 208. The outputs of these measurement devices 216 constitute conversion device readings. One or more other measurement devices measure the work performed by each server. The outputs of these devices constitute computer utilization readings. For example, one or more measurement devices 218 measure the work performed by the server No. 1.

One or more other measurement devices 220 measure the outcome of unproductive use of gas by the servers and/or the fuel cell 208. For example, at least one of the measurement devices 220 may correspond to a temperature sensor for measuring temperature in the “hot” isle 206. In addition, the measurement devices 220 may include one or more other types of gas sensors, dispersed at different locations within the data processing environment.

FIG. 3 graphically depicts one principle on which the analysis system 104 is based. In that simplified setting, the environment 106 supplies input energy to any plurality of resource consumption devices 302, such as direct resource consumption devices (e.g., fuel cells, generators, etc.), and/or indirect resource consumption devices (e.g., servers, etc.). The resource consumption devices 302 use the input energy, and, as an outcome, convert the input energy into different manifestations of output energy. For example, a fuel cell uses the input energy to yield productive output energy (e.g., electrical energy), as well as unproductive output energy (e.g., heat). Likewise, a server uses the input energy to produce productive work (e.g., CPU and memory utilization), and unproductive output energy (e.g., heat).

The analysis system 104 applies the principle of conservation of energy to determine whether the output energy is approximately equal to the input energy. If so, the resource consumption devices 302 are operating in an expected normal manner. If not, then the analysis system 104 concludes that there is energy that is unaccounted for in the energy exchange illustrated by FIG. 3.

One explanation for the discrepancy between input and output energy is that there is a leak in the resource distribution system 114. For example, a leak may occur in any gas conduit, any manifold, etc. Or the leak may occur somewhere within a fuel cell itself, e.g., prior to reaching whatever mechanism actually converts the gas to electrical energy.

Another explanation for the discrepancy is that at least one fuel cell is no longer converting gas into electrical energy in an expected manner. As noted above, this issue may stem from some intrinsic failure of the fuel cell, such as a broken or misbehaving part. Or the failure may result from the particular manner in which the fuel cell has been driven over time, resulting in a more repaid degradation in its abilities compared to other fuel cells, which are driven in a less severe manner.

More specifically, the analysis system 104 can perform the analysis illustrated in FIG. 3 for different analysis scopes within the environment 106, each associated with a starting point and an ending point along a “direction” of energy flow within the environment 106. In FIG. 1, for instance, the direction of energy flow is generally downward, e.g., from the top of the figure to its bottom. Each analysis scope is also associated with one or more resource consumption devices that are encompassed by the analysis scope.

For example, at one extreme, an analysis scope may start at the main conduit that supplies gas to the entire environment 106 (e.g., corresponding to the resource source 118). That analysis scope may encompass all of the fuel cells that receive gas from the main gas conduit via the resource distribution system 114. Or that analysis scope may additionally take into consideration the work performed by the servers which are powered by the fuel cells. At another extreme, an analysis scope may start at a particular conduit that feeds gas directly into a single fuel cell within a single rack. That analysis scope may terminate with a consideration of the output electrical energy generated by the fuel cell, or may additionally encompass the work performed by the servers that are powered by the fuel cell.

Hence, the collection of resource consumption devices 302 under consideration, as depicted in FIG. 3, may differ for different analysis scopes. More specifically stated, the analysis system 104 can determine, for each analysis scope, whether the total amount of gas that is flowing into the analysis scope is matched by the total amount of gas that is used within the analysis scope, and which is manifested by any forms of output energy produced by the resource consumption device(s) that are encompassed by the analysis scope. That is, if the analysis scope can be metaphorically viewed as a box that brackets one or more resource consumption devices, the analysis system 104 determines whether the energy flowing into the box matches the energy flowing out of the box, reflecting the conversion of the gas into different forms of output energy (electrical energy, server work, etc.).

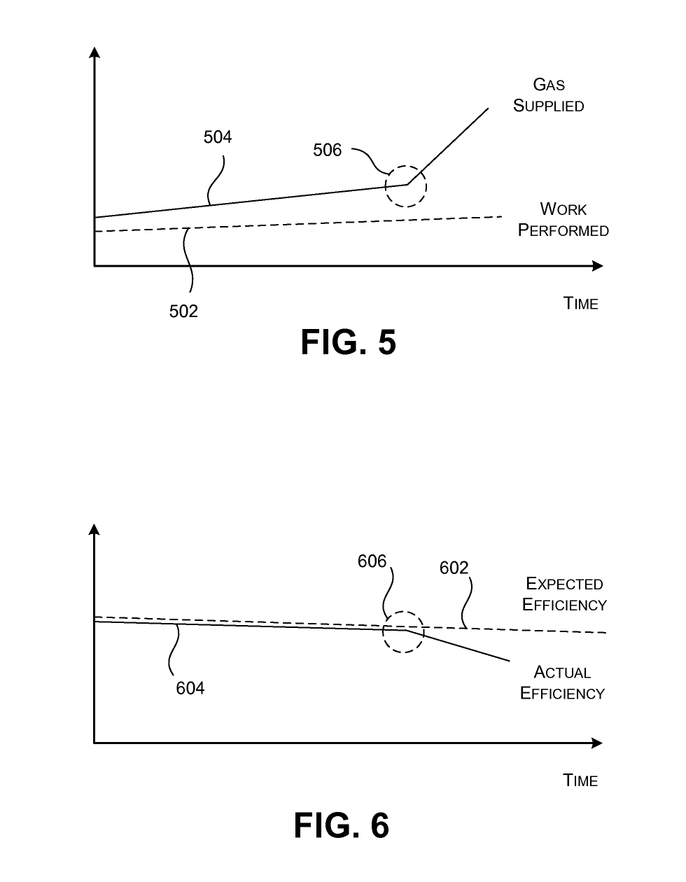

FIG. 4 shows one implementation of the analysis system 104 of FIG. 1. The analysis system 104, as said, may be implemented by one or more computing devices. The computing devices may be provided at a single site or distributed over plural sites. The computing devices may further be co-located with the environment 106 or located at a different site with respect to the environment 106.

The analysis system 104 includes an information collection module 402 for collecting readings from the different measurement devices described above. That is, the readings include flow readings collected from one or more flow meters dispersed throughout the environment 106. The readings also include conversion device readings that describe the output energy generated by the energy conversion devices. The readings also include computer utilization readings which describe the work performed by the electrically-powered devices in the environment 106 (e.g., the servers within the racks). The readings can also include other expenditure readings which characterize any unproductive energy generated by the energy conversion devices, the electrically-powered devices, etc. Although not shown in FIG. 4, the information collection module 402 may also receive readings produced by other types of gas sensors. A data store 404 may store all of the above-described readings using any data structure.

Cross-referencing the explanation of FIG. 3 with the description of FIG. 4, the conversion device readings, computer utilization readings, and other expenditure readings represent the different forms of output energy generated by the resource consumption devices 302, reflecting, in turn, the outcome of the use of the gas. The flow readings represent the input energy fed to the resource consumption devices 302.

An analysis module 406 compares the input energy which is fed to the resource consumption devices 302 with the energy that is output from the resource consumption devices 302 to identify any anomalies within the environment 106. The analysis module 406 then stores its conclusion as analysis output information in a data store 408. More specifically, the analysis module 406 may perform at least two functions, which may be performed separately or together in integrated fashion. As a first function, the analysis module 406 may determine whether an anomaly exists in the environment 106. In a second function, the analysis module 406 determines where the anomaly exists in the environment. That is, in the second function, the analysis module 406 determines what component(s) of the environment 106 are responsible for the anomaly.

As to the first function, and as explained above, the analysis module 406 can compare the input energy with the output energy for a plurality of analysis scopes in the environment 106. That is, the analysis module 406 can determine, for each analysis scope, whether the total amount of gas that is flowing into the analysis scope is matched by the total amount of gas that is used by gas consumption devices within the analysis scope, and as exhibited by the different forms of output energy generated by the gas consumption devices.

More specifically, in one case, the analysis module 406 may perform analysis which takes account for all of the energy that flows into and out of an analysis scope. In another case, the analysis module 406 can determine whether the output energy is deficient by consulting reference information. The reference information identifies how much energy is expected to be generated, given various input factors. Here, however, the analysis module 406 need not account for all the ways that energy may flow out of an analysis scope, but may just ask whether the actual amount of productive output energy matches the energy that is expected.

Consider the particular example in which the analysis scope targets a particular fuel cell under consideration. Here, the analysis module 406 examines the input energy that is fed into the fuel cell (corresponding to the amount of gas supplied to the fuel cell), and the amount of productive energy that is output from the fuel cell (corresponding to the electrical power generated by the fuel cell). The analysis module 406 can then consult efficiency reference information for that fuel cell, which identifies an amount of energy that is expected to be produced by the fuel cell, given the gas supply level, the fuel cell's age, and/or other factors. The analysis module 406 can then compare the actual energy that is produced by the fuel cell with the expected energy to determine whether there is an anomaly in the operation of the fuel cell, or the supply of gas that feeds the fuel cell. The analysis module 406 can make this determination without explicitly taking into account unproductive forms of energy that may be produced by the fuel cell, such as heat.

The reference information may be obtained from any source. In one case, the reference information may correspond to a pre-established equation or table that defines the expected performance of an energy-consuming component. That pre-established equation or table may originate from the manufacturer of the component, or perhaps an industry or standards body to which the component pertains. Alternatively, or in addition, the analysis system 104 can generate the reference information by analyzing the performance of the specific component under consideration over an extended period of time. That performance may establish a trend which defines the expected manner of operation of the component under consideration on a future occasion. Alternatively, or in addition, the analysis system 104 can generate the reference information by analyzing the behavior of other components of the same type as the component under consideration, over an extended period of time. Again, the performance of the similar components establishes a trend which defines the expected manner of operation of the component under consideration.

Generally, FIG. 4 shows an arrow which points from the data store 408 to the analysis module 406. This arrow represents any implementation in which a current analysis of a component under consideration dynamically contributes to reference information for that component. For example, the current analysis can contribute to a trend defined by the reference information.

As to the second function, the analysis module 406 can compute the location of a potential failure (e.g., a leak or a degraded component) using a rules-based investigation. For example, one rule may stipulate that an anomaly that only manifests itself at a particular leaf node in a gas distribution system represents a failure associated with that leaf node alone. For example, an anomaly that only manifests itself in the supply of gas to a particular fuel cell represents a failure of that fuel cell alone. In other cases, the analysis module 406 can work its way up and down the resource distribution system 114 to isolate the cause of failure in the environment 106.

For example, in FIG. 1, assume that a leak has occurred within the manifold 122 itself. The analysis module 406 can perform the above-described energy analysis with respect to each output conduit which exits the manifold 122. In other words, each output conduit demarcates the starting point of a scope of analysis. The analysis module 406 will discover, through this investigation, that there is no problem with these output conduits per se, or any downstream components. That is, for each such output conduit, the analysis module 406 can determine that the total amount of gas that is flowing through this conduit matches the total amount of energy that is produced by the “downstream” resource consumption devices on the basis of this gas.

On the other hand, when the analysis module 406 repeats the same analysis with respect to the gas flowing into the manifold 122 via an input conduit, it will detect an anomaly. This is because gas is being lost through the manifold 122, such that the total amount of gas flowing into the manifold 122 does not match the total amount of energy that is produced by downstream resource consumption devices on the basis of the gas. The analysis module 406 can then conclude that the manifold 122 is the source of the problem, or lies in proximity to the source of the problem.

The analysis module 406 can use any technique or techniques to perform the above analysis. In one case, as described in the example above, the analysis module 406 can apply a discrete algorithm having a plurality of empirically-derived rules, threshold values, etc. In other cases, the analysis module 406 can use a machine-trained model, an expert system, etc. to perform the above analysis. In any case, the analysis module 406 can also cross-reference its failure detection results with the output results provided by other types of gas sensors, such as chemical sensors, acoustic sensors, etc. The analysis module 406 can establish a level of confidence to its conclusions based on a determination of whether its results agree with the output of the other gas sensors.

In the above examples, the analysis module 406 detects an actual failure within the environment 106. In other cases, the analysis module 406 may predict future failures within the environment 106. For example, the analysis module 406 can compute the downward trend in efficiency of a fuel cell based on readings taken over a span of time. The analysis module 406 can then extend the trend into the future through extrapolation to provide an estimate of the remaining life of the fuel cell.

In other cases, the analysis module 406 may compare the performance of a fuel cell with telltale signatures associated with previously-encountered problems with fuel cells of this type. The analysis module 406 may leverage that comparison to indicate that a failure has occurred, or is about to occur. The telltale signatures are made up of readings taken from the fuel cell of the same type on previous occasions, these readings being associated with a failure or subsequent failure.

A control module 410 generates control output information in response to the analysis output information produced by the analysis module 406. The control module 410 can use the control output information to control the operation of any output devices within the environment 106, such as valves, alarms, ventilation systems, etc.

In one case, the control module 410 may perform different actions based on different levels of severity associated with a detected anomaly. For a low-severity anomaly, the control module 410 can generate an alarm. A technician can manually respond to the alarm by examining the environment 106, guided by any failure location information that the analysis module 406 is able to provide. For a more severe anomaly, the control module 410 may automatically close one or more valves to stop the flow of gas in the environment 106, e.g., to prevent an explosion.

In conclusion to the description of FIG. 4, the analysis system 104 may have a number of advantages over traditional methods of detecting gas leaks. Consider the particular case in which the environment 106 corresponds to a data processing environment, such as a large data center. A data center is typically a windy environment, e.g., due to its use of a ventilation system to remove hot air from the data center. Upon an occurrence of a gas leak, the ventilation system may therefore quickly dilute the errant gas; this factor, in turn, may make it difficult for a traditional gas sensor to detect the gas leak, even if the sensor is positioned in close proximity to the leak. A data center is also typically a large environment. The large space is another factor that may contribute to the dilution of gas produced by a gas leak.

In contrast, the analysis system 104 can successfully detect a leak because it detects the performance-related consequences of the leak, not the physical presence of the leaked gas per se. Indeed, the analysis system 104 can potentially detect even subtle leaks that a traditional gas sensor would have difficulty detecting, even in non-windy conditions.

Furthermore, the likelihood that a traditional gas sensor will detect a leak depends, in part, on the placement of the gas sensor relative to the source of the leak. In contrast, the above-described strategy is less dependent on the placement of its measuring devices. Insofar as the leak is manifested in the degraded performance of some component in the environment 106, the leak can be detected, even if the measurement devices that are used to identify the degraded performance are not located close to the actual source of the leak.

As a final consequence of the above-described features, the analysis system 104 may more quickly identify and locate a gas leak compared to traditional techniques. This reduces the danger posed by the leak, as well as the loss of revenue associated with the leak.

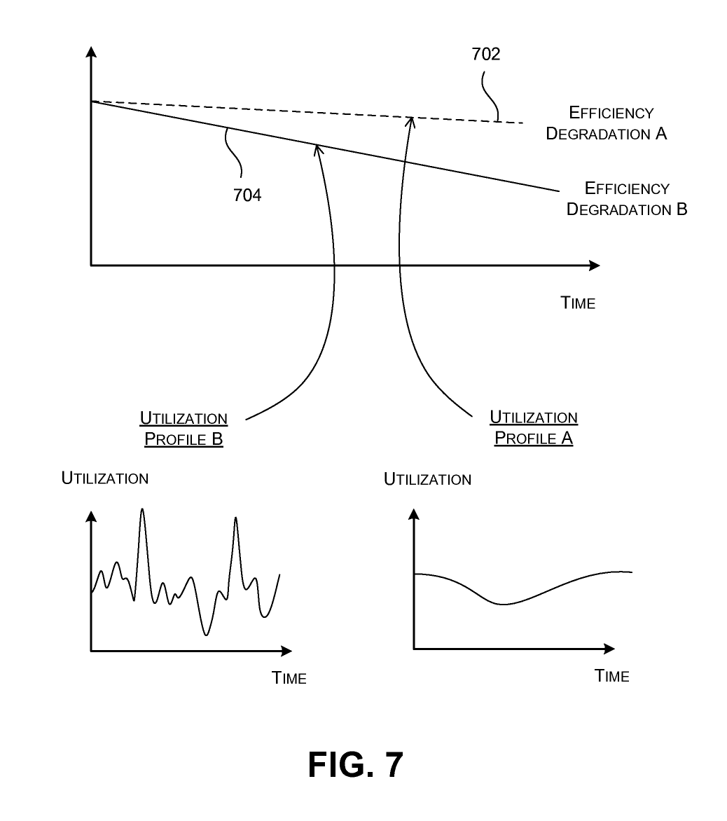

FIGS. 5-7 show graphs for use in explaining different types of analysis that may be performed by the analysis system 104 of FIG. 4. Starting with FIG. 5, this figure shows analysis performed with respect to one or more servers within a data processing environment. More specifically, assume that the analysis pertains to work performed by a collection of servers within a rack, where those servers are powered by a single gas-powered fuel cell.

A first curve 502 represents work performed by the servers. A second curve 504 represents an amount of gas that is fed to the fuel cell over a span of time (where, again, that fuel cell supplies power to the servers). The span of time may correspond to second, minutes, hours, etc. As can be expected, an increase in the amount of work demanded by the servers (reflected by the first curve 502) is reflected by an increase in the amount of gas that is fed to the fuel supply, as a greater amount of work demands more fuel. But at juncture 506 an abrupt change occurs. From this point on, the amount of work that is performed by the servers continues to slowly increase at the same rate as before; but the amount of gas that is required to perform the desired work markedly increases. That abrupt change may be attributed to a gas leak, a failure of the fuel cell, and/or some other problem in the environment 106.

Advancing to FIG. 6, this figure illustrates one way in which the analysis system 104 can leverage reference information. In that figure, a first curve 602 describes an efficiency that is expected for a fuel cell or other component of the environment 106. In other words, that curve 602 defines the efficiency at which the fuel cell is expected to convert gas to electrical energy for a particular gas input flow level, over time. The curve 602 may correspond to a particular curve in a family of curves associated with different respective flow levels. In contrast, a second curve 604 defines the actual efficiency of the fuel cell under consideration.

Note that the actual efficiency of the fuel cell generally matches the expected efficiency, until juncture 606. At that point, the efficiency of the actual fuel cells markedly degrades. The degradation may indicate that a gas leak has occurred, and/or that there is some failure of the fuel cell due to an intrinsic characteristic of the fuel cell, and/or that there is some problem in the manner in which the fuel cell is being driven by the servers to which it supplies power.

As to the last-mentioned explanation, FIG. 7 shows the effects that two server loads may have on a fuel cell, over time. More specifically, assume that, in a first case A, a fuel cell is asked to supply electrical energy to servers that exhibit slowly-varying demand, exemplified by the sample of the demand levels labeled “Utilization Profile A.” In a second case B, a fuel cell of the same type is asked to supply electrical energy to servers that exhibit more erratic demand, exemplified by the “spikey” sample of the demand levels labeled as “Utilization Profile B.”

A first curve 702 describes the degradation in efficiency level of the fuel cell that is driven in accordance with the Utilization Profile A, while a second curve 704 describes the degradation in efficiency level of the fuel cell that is driven in accordance with the Utilization Profile B. Note that the first curve 702 shows a more gradual decline compared to the second curve 704, indicating that the load imposed by Utilization Profile B is much “harder” on the fuel cell compared to the load imposed by the Utilization Profile A. Less formally stated, the spikey demand level profile may cause the fuel cell to wear out sooner compared to the more gradual demand level profile. Note, however, that the two utilization profiles described above, and the effects of these profiles on the fuel cell's degradation, are cited by way of example, not limitation. In other environments, other aspects of a demand profile (e.g., other than “spikiness”) may contribute to the premature degradation in a fuel cell.

The analysis system 104 can leverage the above findings in different ways. In one case, a data center engineer can use the results of the analysis to change the work that is performed by the servers, e.g., to reduce the spikiness of the demand level, and by doing so, prolong the life of the fuel cell. In a sense, the failure represented by the second curve 704 is not caused by an intrinsic problem within the fuel cell itself, or a leak in the supply of gas leading to the fuel cell, but the manner in which the fuel cell is being driven. In other words, the “leak” in the case of FIG. 7 more abstractly represents the waste of gas through the inefficient use of the fuel cell.

B. Illustrative Processes

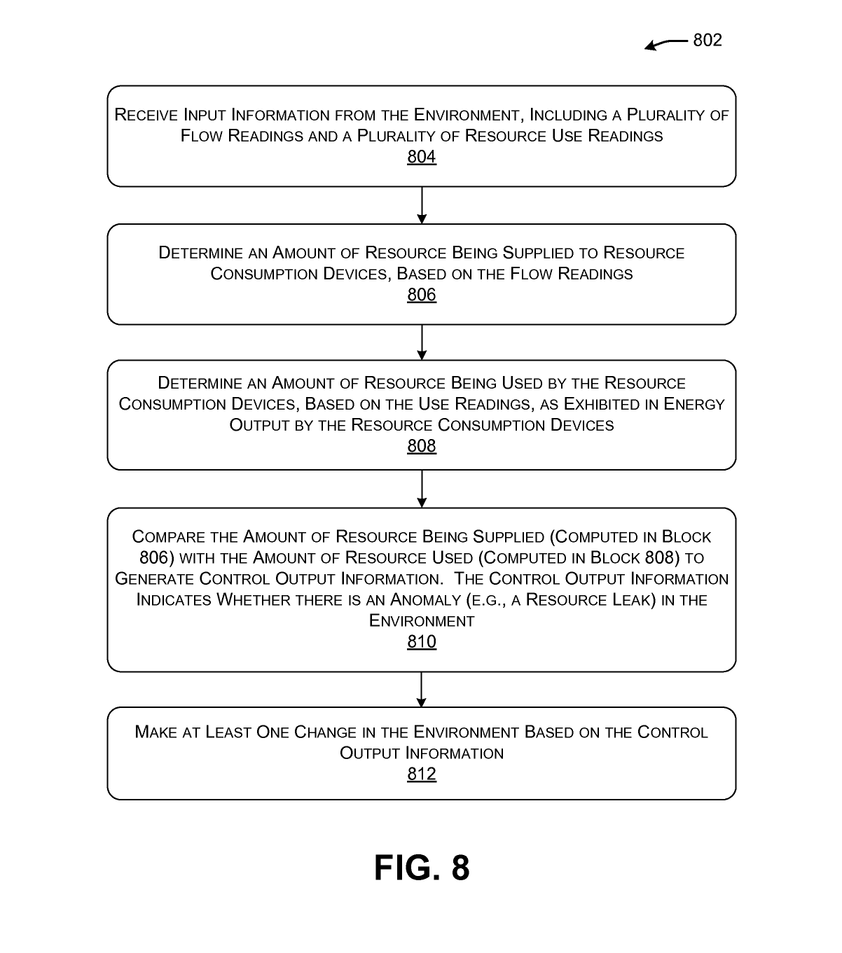

FIG. 8 is a process 802 that explains the operation of analysis system 104 of FIGS. 1 and 4 in flowchart form. Since the principles underlying the operation of the analysis system 104 have already been described in Section A, certain operations will be addressed in summary fashion in this section.

In block 804, the analysis system 104 receives input information from an environment 106, such as a data processing environment. The environment performs a function based on the supply of a resource, such as gas. The input information may include a plurality of flow readings that describe a supply of the resource to one or more resource consumption devices, via a resource distribution system 114 (such as a collection of manifolds and gas conduits). The input information may also include a plurality of resource use readings that describe the outcome of the use of the resource within the environment 106 by the resource consumption devices. The resource consumption devices may include direct consumers of the resource, such as fuel cells or generators, as well as indirect consumers of resource, such as computing devices which receive electrical energy supplied by the fuel cells or generators.

In block 806, the analysis system 104 determines an amount of resource being supplied to the resource consumption devices, based on the plurality of flow readings. In block 808, the analysis system 104 determines an amount of resource being used in the environment 106 by the resource consumption devices, based on the plurality of use readings. The plurality of use readings in turn, reflect output energy produced as a result of the use of the resource.

In block 810, the analysis system 104 compares the amount of resource computed in block 806 with the amount of resource computed in block 808 to generate control output information. The control output information indicates whether there is a mismatch between an amount of resource that is supplied, relative to the amount of resource that is being used. Such a mismatch is indicative of a resource leak in the environment 106, or some other failure. The analysis system 104 can perform the comparison of block 810 in different ways, such as by converting the flow readings and the use readings into readings expressed in comparable energy units, and then comparing the input energy to the output energy. Or the analysis system 104 can perform the comparison by consulting reference information, e.g., by determining whether the actual output power of a fuel cell matches an expected output power, for a given amount of input gas, and for a given fuel cell age, etc.

In block 812, the analysis system 104 makes at least one change in the environment 106, based on the control output information, to address the problem identified in block 810.

C. Representative Computing Functionality

FIG. 9 shows computing functionality 902 that can be used to implement any aspect of the setting 102 of FIG. 1. For instance, the type of computing functionality 902 shown in FIG. 9 can be used to implement the analysis system 104, or any aspect of a server within a rack, and so on. In all cases, the computing functionality 902 represents one or more physical and tangible processing mechanisms.

The computing functionality 902 can include one or more processing devices 904, such as one or more central processing units (CPUs), and/or one or more graphical processing units (GPUs), and so on.

The computing functionality 902 can also include any storage resources 906 for storing any kind of information, such as code, settings, data, etc. Without limitation, for instance, the storage resources 906 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 902. The computing functionality 902 may perform any of the functions described above when the processing devices 904 carry out instructions stored in any storage resource or combination of storage resources.

As to terminology, any of the storage resources 906, or any combination of the storage resources 906, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 902 also includes one or more drive mechanisms 908 for interacting with any storage resource, such as a hard disk drive mechanism, an optical disk drive mechanism, and so on.

The computing functionality 902 also includes an input/output module 910 for receiving various inputs (via input devices 912), and for providing various outputs (via output devices 914). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 916 and an associated graphical user interface (GUI) 918. Other output devices include a printer, a model-generating mechanism, a tactile output mechanism, an archival mechanism (for storing output information), and so on. The computing functionality 902 can also include one or more network interfaces 920 for exchanging data with other devices via one or more communication conduits 922. One or more communication buses 924 communicatively couple the above-described components together.

The communication conduit(s) 922 can be implemented in any manner, e.g., by a local area network, a wide area network (e.g., the Internet), point-to-point connections, etc., or any combination thereof. The communication conduit(s) 922 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 902 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An analysis system, implemented by one or more computing devices, for controlling an environment that performs a function based on consumption of a resource, comprising:
a collection module configured to receive input information from the environment, the input information including:
a plurality of flow readings that describe a supply of the resource to one or more resource consumption devices within the environment, via a resource delivery system; and
a plurality of resource use readings that describe an outcome of the use of the resource within the environment by said one or more resource consumption devices;
an analysis module configured to generate control output information by:
determining an amount of input energy that is being supplied to said one or more resource consumption devices, based on the plurality of flow readings;
determining an amount of output energy that is produced by said one or more resource consumption devices, based on the plurality of use readings; and
comparing the amount of input energy to the amount of output energy, to provide the control output information,
the control output information indicating whether there is an anomaly within the environment; and
a control module configured to control at least one output device within the environment based on the control output information.

2. The analysis system of claim 1, wherein;
wherein the resource is natural gas,
the resource delivery system is a gas delivery system,
the plurality of flow readings include readings made by gas flow meters within the gas delivery system, and
said one or more resource consumption devices include one or more gas conversion devices for converting the gas into electrical energy.

3. The analysis system of claim 2, wherein said one or more gas conversion devices comprise one or more fuel cells.

4. The analysis system of claim 2, wherein said one or more gas conversion devices comprise one or more generators.

5. The analysis system of claim 2, wherein said one or more resource consumption devices further include one or more electrically-powered devices for performing respective functions based on electrical energy supplied by said one or more gas conversion devices.

6. The analysis system of claim 5, wherein the environment is a data processing environment, and wherein said one or more electrically-powered devices correspond to computing devices within the data processing environment.

7. The analysis system of claim 6, wherein the plurality of use readings include conversion device readings that describe an amount of electrical energy that is being generated by said one or more gas conversion devices.

8. The analysis system of claim 7, wherein the plurality of use readings also include computer utilization readings which describe an amount of work that is being performed by the computing devices.

9. The analysis system of claim 8, wherein the plurality of use readings also include other expenditure readings which describe an amount of unproductive energy generated by said one or more gas conversion devices and/or the computing devices.

10. The analysis system of claim 2, wherein the anomaly indicates a loss of gas within the resource delivery system due to a leak.

11. The analysis system of claim 2, wherein the anomaly indicates that there is an abnormal degradation of at least one gas conversion device.

12. The analysis system of claim 11, wherein the abnormal degradation of said at least one gas conversion device ensues from an intrinsic failure in said at least one energy conversion device.

13. The analysis system of claim 11, wherein the abnormal degradation of said at least one gas conversion device ensues from a nature of a prior load imposed on said at least one gas conversion device over a span of time.

14. The analysis system of claim 2, wherein the analysis module is configured to perform said comparing by using efficiency information, the efficiency information reflecting an expected efficiency of said one or more gas conversion devices in converting the gas into electrical energy.

15. The analysis system of claim 1, wherein the analysis module is configured to generate the control output information with respect to a plurality of defined analysis scopes, each analysis scope encompassing a set of one or more resource consumption devices.

16. The analysis system of claim 1, wherein said at least one output device is a valve that is closed by the control module upon an indication of an anomaly, to thereby control an amount of the resource that is fed to said one or more resource consumption devices.

17. A method, performed by one or more computing devices, for detecting and responding to gas leaks in a data processing environment, comprising:
receiving input information from the data processing environment, the input information including:
a plurality of flow readings that describe a supply of gas to one or more gas consumption devices, via a gas delivery system; and
a plurality of gas use readings that describe an outcome of the use of the gas within the data processing environment by said one or more gas consumption devices;
determining an amount of gas that is being supplied to said one or more gas consumption devices, based on the plurality of flow readings;
determining an amount of gas that is being used in the data processing environment by said one or more gas consumption devices, based on the plurality of use readings, and as exhibited by output energy produced by said one or more gas consumption devices; and
comparing the amount of gas that is being supplied to said one or more gas consumption devices, to the amount of gas that is being used by said one or more gas consumption devices, to generate control output information,
the control output information indicating whether the gas that is being supplied to said one or more gas consumption devices does not match the gas that is being used by said one or more gas consumption devices; and
making at least one change in the data processing environment, based on the control output information, to address a situation in which the gas that is being supplied does not match the gas that is being used.

18. The method of claim 17, further comprising generating control output information for different respective analysis scopes, each analysis scope encompassing a set of one or more gas consumption devices.

19. The method of claim 17, wherein said making a change includes closing at least one valve that delivers gas to said one or more gas consumption devices.

20. A computer readable storage medium for storing computer readable instructions, the computer readable instructions providing an analysis system when executed by one or more processing devices, the computer readable instructions comprising:
logic configured to receive input information from an environment that performs a function based on consumption of a resource, the input information including:
a plurality of flow readings that describe a supply of the resource to one or more resource consumption devices, via a resource delivery system; and
a plurality of resource use readings that describe an outcome of the use of the resource within the environment by said one or more resource consumption devices;
logic configured to determine an amount of input energy that is being supplied to said one or more resource consumption devices, based on the plurality of flow readings;
logic configured to determine an amount of output energy that is produced by said one or more resource consumption devices, based on the plurality of use readings; and
logic configured to compare the amount of input energy to the amount of output energy, to provide control output information,
the control output information indicating whether there is a mismatch between the input energy and the output energy,
the analysis system configured to generate the control output information for different respective analysis scopes, each analysis scope encompassing a set of one or more resource consumption devices.
